(19) United States
(12) Patent Application Publication
(10) Pub. No.: US 2009/0209694 A1
(43) Pub. Date: Aug. 20, 2009

(54) Process for Nanocomposites Preparation, and Nanocomposites

(75) Inventors: Susana Alcira Liberman, Porto Alegre (BR); Luciana Portal Da Silva, Porto Alegre (BR); Tarcisio Pelegrini Junior, Porto Alegre (BR); Ronilson Vasconcelos Barbosa, Curtiba (BR); Raquel Santos Mauler, Porto Alegre (BR)

Correspondence Address: BIRCH STEWART KOLASCH & BIRCH, PO BOX 747, FALLS CHURCH, VA, 22040-0747, US

(73) Assignees: BRASKEM S.A., Camacari-Ba (BR); Universidade Federal Do Rio Grande Do Sul, Porto Alegre-Rs (BR)

(21) Appl. No.: 11/988,747

(22) PCT Filed: Jul. 14, 2006
(86) PCT No.: PCT/BR2006/000143

§ 371 Date: Apr. 15, 2008

(30) Foreign Application Priority Data
Jul. 15, 2005 (BR) PI0503777-8

(51) Int. Cl. C08K 3/34

(52) U.S. Cl. 524/445

(57) ABSTRACT

The present invention relates the preparation process of nanocomposites polyolefins based on organophilic clay and polyolefins. More specifically, the present invention relates to a process to prepare nanocomposites, which provides more efficient exfoliation of organophilic clay particles in the polymeric matrix and, hence, a product with significantly improved mechanical, thermal and barrier properties, and good optical properties.

The nanocomposite product obtained by means of the process herein described and claimed, constitutes, hence, a second aspect of the present invention.

### TECHNICAL FIELD

The present invention relates the preparation process of nanocomposites polyolefins based on organophilic clay and polyolefins. More specifically, the present invention relates to a process to prepare nanocomposites, which provides more efficient exfoliation of organophilic clay particles in the polymeric matrix and, hence, a product with significantly improved mechanical, thermal and barrier properties, and good optical properties.

### INVENTION FUNDAMENTALS

Nanotechnology represents an up-to-date, widely developed discipline. One of its application fields comprises preparing materials, commonly named nanocomposites, in which the interaction between the components occurs in nanometric or molecular scale and, hence, different properties in comparison to conventional material. Due to their special properties, the nanocomposites present applications in several technological areas, such as catalysis, electronics, magnetic devices, paints and coatings.

The nanocomposites are hybrid materials in which one of the components is the matrix, where the particles of the second component are dispersed, which is a charge of inorganic nature with nanometric dimensions, named nanoparticles or nanocharges.

The incorporation of inorganic nanometric charges in polymeric matrices lead to an increase in the mechanical strength, hardness and thermal stability of the polymers, as well as improved barrier and flame delay properties, due to the synergy between the different components used.

Studies on preparation and characterization of nanocomposites and the interactions and effects that occurring at the molecular level has been explored, in an attempt to obtain improved and better oriented materials to the application they are intended to.

According to the intended application, several types of charges may be used, which are different from each other, for example, concerning morphological properties, thermal resistance or chemical reactivity. Among the most commonly used charges for polymeric matrix nanocomposites are the clays and silicates the morphology lamellar or laminar, carbonates, sulfates, aluminum-silicates and metallic oxides.

Particles with nanometric dimensions are usually hydrophilic, and, hence, before they are dispersed in the polymeric matrix, which is usually hydrophobic-like, they need to be modified, so as to become compatible with the polymers.

Agents able to chemically modify the structure of inorganic charges and/or of the polymeric matrix are used to increase chemical compatibility between the inorganic charges and the polymeric matrix, providing, hence, better dispersion. Thus, the interaction between the components is improved, both by the previous insertion of a hydrophilic monomer in the polymeric chain, or by organic passivation of inorganic nanoparticles surface. Thereupon, polyolefins modified with polar groups are used as compatibleness agents in olefin polymers compositions containing nanocharges.

The mixture between the nanocomposite components can be obtained by simple intercalation, which consists of inserting the polymeric chain in empty spaces in the inorganic solid structure. These empty spaces are named interlamellar galleries, and can be enlarged with previous use of specific substances, named expansion or swelling agents.

On the other hand, for the mixture between the nanoparticles and polymeric matrix to occur properly, the exfoliation of particles with lamellar inorganic structure, such as clays, is pursued, which comprises its total or partial delamination, attained by chemical transformation of its structure and mechanical shaking and/or ultrasound application. The purpose of the chemical transformation is to modify the clays polarity, increasing, thus, the interlamellar space, facilitating later exfoliation.

A great number of patents and publications describing the use of intercalated clays upon nandcomposites preparation are found in the state of the technique.

Document US 2003/0232912, for example, describes the use of an intercalating agent selected from the group, consisting of hydroxy-substituted carboxylic acid ester, amide, hydroxy-substituted amide and oxidized polyolefins upon polyolefin nanocomposites production, obtained from the mixture, in melted state, of polyolefin, clay and the intercalating agent.

On its turn, document WO 2004/041721 relates to a process for preparation of a polyolefin nanocomposite comprising the mixture, in melted state, of polyolefin, nanoparticles and a non-ionic tensoactive. In that process, the non-ionic tensoactive is responsible for intercalates and exfoliates the nanoparticle, and disperses it on the polyolefin matrix, to form the nanocomposite.

An improved way to increase nanoparticles dispersiveness on the polymeric matrix may be seen in U.S. Pat. No. 6,462,122. Therein, a material composed of layers, such as clay, is at first put in contact with an onium ion (cations). Simultaneously, or after that first contact, an intercalating agent composed of a melted polyolefin oligomer or a melted polyolefin polymer is added to the material lamellar, intercalated with the onium ion to form a concentrate. According to that patent, the compound formed by such process, or the same exfoliate, may be easily dispersed, homogeneously and uniformly, on a polymeric matrix, ensuring new properties upon materials strength.

Similarly, U.S. Pat. No. 6,407,155 proposes the preparation of lamellar materials intercalated by means of a reaction with a coupling agent, together with the intercalation of a compatibilizer agent/onium ion spacing, creating, thus, a lamellar material, which is reacted by means of a binding agent in the —OH group portion, and intercalated with onium ion. The material is, thereafter, intercalated with an oligomer or polymer inserted in the lamellar material galleries.

Another way to increase particles dispersion consists of using a clay mixture. As it may be observed in U.S. Pat. No. 6,391,449, using a mixture of clay during processing polymer in melted state, improves the particles delamination, leading to their better dispersion.

The exfoliation of inorganic charge particles for nanocomposites preparation, according to U.S. Pat. No. 6,271,298, is facilitated by submitting the clay to a previous surface treatment, with negatively charged organic molecules.

Likewise, with the purpose of providing dispersion of natural phyllosilicates or hydrophilic clays in several polymers, a surface treatment is provided in document US 2004/0214921. The phyllosilicate/polymer nanocomposites described in that invention are obtained by means of the absorption of a tensoactive polymer in a surface of a natural phyllosilicate or a phyllosilicate with surface modified with an organic tensoactive.

As it has been previously mentioned, in polymeric nanocomposites, as the clay is polar and inorganic, and therefore, incompatible with organic polymer, it is required to increase the clay compatibility and dispersion within the polymeric matrix.

Thereupon, there are, in the state of the technique, several documents describing a wide variety of dispersing agents. In particular, document WO 2004/085534 proposes the use of an olefinic polymeric peroxide as dispersion agent, which, in addition to increasing chemical affinity between the components, intensifies the nucleation of the olefinic polymeric material, improving the nanocomposite mechanical properties.

Patent application EP 1.408.077, on its turn, proposes a composition comprising a poliolefin with functional groups, prepared directly by the polymerization of olefinics monomers with co-monomers with functional groups, and a single-site catalyst, associated to a charge with nanometric dimensions and, optionally, a polymeric matrix. In this case, the polyolefin containing functional groups act as a compatibilizer agent, providing improved properties to the polymeric composition.

Clay intercalated by an organic compound, with a non-polar portion bound to a polar portion, is disclosed in U.S. Pat. No. 6,500,892. Therein, the use of a saturated isopropenic oligomer is suggested, which simulates the basic structure or parts of the main chain of homopolymers and co-polymers of propylene and ethylene. Thus, the non-polar portion tends to be compatible with such polymers, especially propylene and ethylene co-polymers. On the other hand, the polar portion tends to show affinity with the clay, increasing, hence, the polymer compatibility with the exfoliated clay.

Document US 2004/0220305 describes a method to produce a concentrated organophilic silicate through the use of an aqueous suspension or a moist cake of filter from an organophilic silicate with a monomer, an oligomer or a polymer, whose objective is to displace the water associated to the organophilic silicate particles. In that method, the monomer, oligomer or polymer physically displaces the water from the clay agglomerates in the suspension or filter cake, reducing the time and amount of energy spent for organophilic silicate particles drying, before additional processing.

### SUMMARY OF THE INVENTION

The present invention relates the preparation process of nanocomposites polyolefins based on organophilic clay and polyolefins. More specifically, the present invention relates to a process to prepare nanocomposites, which provides more efficient exfoliation of organophilic clay particles in the polymeric matrix and, hence, a product with significantly improved mechanical, thermal and barrier properties, and good optical properties.

The nanocomposite product obtained by means of the process herein described and claimed, constitutes, hence, a second aspect of the present invention.

### FIGURE DESCRIPTION

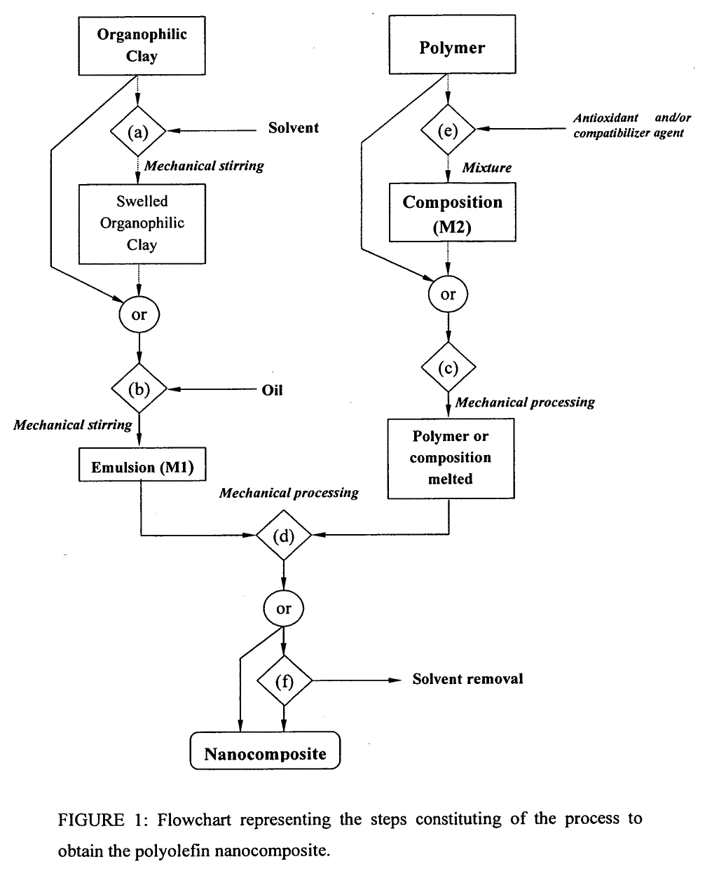

The report is complemented with FIGS. 1, 2 and 3.

The FIG. 1 shows a flowchart representing the steps constituting of the process herein described and claimed.

The FIG. 2 present a schematic of the overall process in the co-rotating twin screw extruder herein described and claimed, and

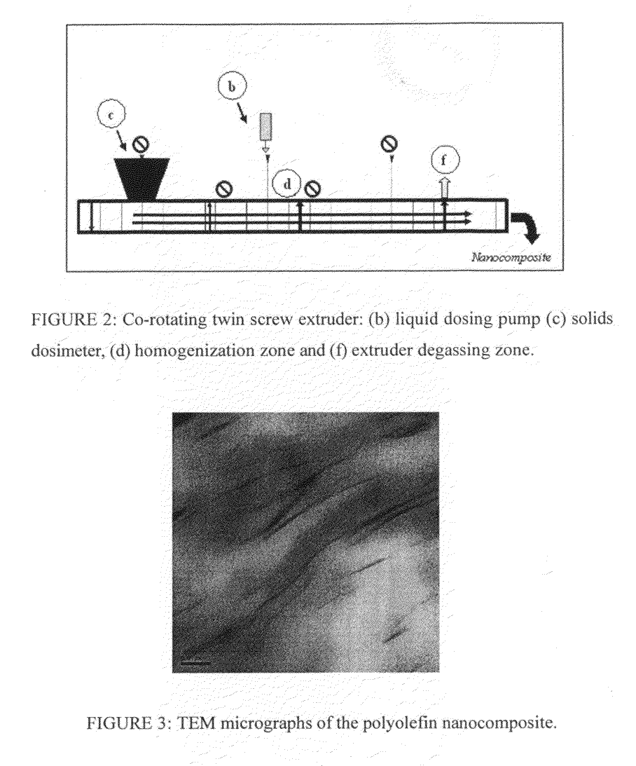

the FIG. 3 show the TEM micrographs of the nanocomposite obtained in the present invention.

### DETAILED DESCRIPTION OF THE INVENTION

The present invention provides a process for preparing the nanocomposites comprising a polymer and an organophilic clay, and having improved toughness, impact strength properties, and thermal properties, such as heat deflection temperature (HDT).

In one embodiment, the process for nanocomposites preparation in the present invention comprises the following steps:

(a) addition of solvent to the organophilic clay to make it swelled;

(b) to add oil to the swelled organophilic clay, and mechanically shake to obtain an emulsion (M1);

(c) separately, heat a polymer until at least its melting point; and

(d) mix the M1 emulsion to the melted polymer.

Optionally, the polymer in step (c) may be previously mixed to an anti-oxidizing and/or compatibilizer agent, step (e), with shaking, so as to obtain a composition M2, which will be later mixed to emulsion M1, following step (c);

(f) solvent removal shall be performed after step (d).

The use of clay's emulsion makes more easy to attain a maximum of exfoliation of the crystal sheets of the clay into the polymeric phase during the mechanical processing and, hence, to obtain polyolefin nanocomposites with higher mechanical and thermal properties.

In another embodiment, it has been discovered that the properties of the nanocomposites can also be improved by mixing the polyolefin and the organophilic clay with an oil and solvent. In this embodiment, the invention provides a process for preparing a nanocomposite wherein the solvent, oil, organophilic clay, and polymer are combined and mixed in an extruder to form a homogeneous nanocomposite material.

The organophilic clay used for preparing the nanocomposite in the present invention comprises a phyllosilicate, superficially modified with an organic tensoactive such as quaternary onioum ion (for example, phosphonium and ammonium cations) or any other organophilic-like clay obtained with the use of other processes described in the state of the technique. The process in the present invention does not require the organophilic clay initially used to have granulometry in the nanometric range, once the process in the present invention is able to exfoliate and disperse the nanometric particles (clay) at a nanometric level. The nanometric particles present at least one dimension in the 0.1 to 100 nanometer (nm) range, where 1 nm correspond to 10⁻⁹ m. The clay shall be used in such proportions that it results in a content within the range from 0.2 to 10% in weight, preferably between 0.5 to 7% in weight, based on the total weight of the final nanocomposite obtained.

The solvent appropriate to step (a) in the present invention is any volatile organic solvent, or a mixture of volatile organic solvents, that present the same relative affinity with the inorganic charge and polymeric matrix of the nanocomposite. The preferably indicated solvents may be one or more polar solvents, such as ketones, aldehydes, alcohols, esters, ethers, amines and organo-halogenated compounds, as well as substances containing two or more of these chemical functions, such as, hydroxy-esters or halogenated esters. More preferably, ketones or esters with 3 to 8 carbons are used, such as propanone, methyl-ethyl-ketone, methyl-isobutyl-ketone, ethyl acetate and butyl acetate. The volatility of the solvent helps to facilitate removal of the solvent, for example in step (f) of the claimed process. Specifically, solvents with a boiling point between 60 a 100° C. at 1 atmosphere. The solvent amount used is generally enough to make the clay swelled; specifically, the solvent amount added is sufficient to cause an increasing of the original volume of the clay between 1 to 3 times. In this case, between 2 to 30 g of solvent per gram of clay.

The oil added to the clay, or to the clay previously swelled with the solvent, shall have a viscosity in the range from 20 to 600 cP at the operation temperature, preferably 100 to 200 cP, to cause shearing appropriate to the process in the present invention, and, additionally, to form a stable emulsion, easy to dose and good processing. The appropriate oils to embody the present invention may be non-polar or polar, and include, among others, mineral oils, the polyethylene-glycol, polypropylene-glycol type, and polyolefins, such as polyethylenes, polypropylenes and polyisobutylenes, with low molecular weight. Anyway, the oil shall be in the liquid state, and to present the viscosity desired at the operation temperature, preferably with initial solidification temperature under room temperature.

The amount of oil typically vary between 0.2 and 12% in weight, more preferably between 0.5 and 6% in weight, based on the total weight of the final nanocomposite obtained.

The shaking used in steps (a) and (b) is preferably performed in vigorous conditions. Any type of shaking system may be used, as long as it performs the mixture with the intensity required.

A wide variety of polymers may be used upon preparation of nanocomposites in the present invention. Among the indicated polymers are polyolefins, such as polyethylene and its copolymers, polypropylene and its copolymers, polar copolymers as EVA, elastomers as poly-isobutylene, poly-isoprene, SBR, SBS, poly(hydroxy alcanoates), and also polystyrene.

Compatibilizer agents, such as polypropylene grafted with maleic anhydride, are optionally mixed to the polymer, to increase chemical compatibility of the polymeric matrix with the clay, in the ratio of 0 to 30% in weight, preferably 0 to 15% in weight, based on the total weight of the nanocomposite obtained.

The temperature in the steps previous to polymer melting is preferably close to room temperature. However, it is possible to conduct the present process in other temperatures, as long as the mediums properties are maintained, and consequently, so is the stability of components and their mixtures.

Steps (c), (d) and (f) of the process in the present invention may be performed by means of any type of operation and with any equipment appropriate for mixing melted polymers and removing solvent. Ideally, these steps are performed in an extruder, in such a way that the polymer or the M2 composition is supplied with the help of a solids dosimeter at the initial part of the extruder, where the melting related to step (c) happens. Thereafter, M1 emulsion is introduced by means of a liquid dosing pump in the extruder homogenization zone, allowing the mixture with the polymer or the M2, provided in step (d). At last, in step (f), the solvent optionally used in step (a) to swell the clay is removed in the extruder degassing zone, with the help of a vacuum pump. After the extrusion, the material is pelleted.

The polyolefin nanocomposite obtained using the present process invention herein described and claimed, present a good balance between toughness and impact strength properties, and thermal properties, specifically heat deflection temperature (HDT). For example, the Flexural Module, Izod Impact and HDT thereof are in the ranges of 1700-2800 MPa, 50-130 J/m, and 100-120° C., respectively.

Nanocomposites prepared in accordance with the invention can be used in the production of sheets, films and panels having valuable properties. Such sheets, films and panels may be shaped by conventional processes, such as vacuum processing or by hot pressing to form useful objects and injection molding. The nanocomposites of the present invention can also be useful for fabrication of extruded films and film laminates, as for example, films for use in food packaging. Such films can be fabricated using conventional film extrusion techniques. In one embodiment, the films can be from about 10 to about 100 microns, and in particular from about 25 to about 75 microns in thickness.

### EXAMPLES

To allow a better understanding of the present invention and clearly show the technical advances obtained, the Examples results are now presented, comprising nanocomposites obtained by means of the production process herein described and claimed, and Comparative Examples, in which some of the conditions anticipated by the state of the technique have been used, specifically, traditional processing in which all the component of the final material are added in the solids dosimeter of the extruder.

The steps constituting of the process herein described and claimed was resumed in a flowchart showed in the FIG. 1.

To prepare the Examples illustrating the present invention, the following methodology has been used:

The propylene homopolymer or propylene heterophasic copolymer (has been physically mixed, at 25° C., to anti-oxidizing agent Irganox B215, and optionally to propylene grafted with maleic anhydride as compatibilizer agent in a mechanical mixer for 15 minutes, obtaining the mixture M2, was added in the solids dosimeter of the extruder, FIG. 2c.

Separately, an emulsion M1 has been prepared at 25° C. following the process in the present invention. From the organophilic clay (30 g), optional addition of solvent has been performed, in an amount enough to make clay swelled, step (a). Thereafter, oil has been added, step (b), also at 25° C., and the emulsion was obtained with the help of mechanical stirring for 15 minutes.

The mixture of M1 with M2 was processed in a reactive co-rotating twin screw extruder, Rheomex PTW 16/25, L/D=25 extruder, using the following temperature profile: 175, 180, 180, 185, 185 and 190° C., corresponding to Zones 1 to 6, respectively.

The mixture containing the composition M2 or polymer was supplied to the extruder with the help of a solids dosimeter, FIG. 2c, whose dosing speed was 0.5 g/min. The emulsion M1, containing the clay, was introduced in the extruder with the help of a liquid dosing pump, FIG. 2b, whose dosing flow varied according to the amount of material to be processed, through an orifice located in the homogenization zone, and was mixed to the already melted composition M2 or polymer, FIG. 2d. To remove the solvent, a vacuum pump was used, introduced in the degassing zone, FIG. 2f. After the extrusion, the material was pelletized.

With the purpose of comparing the effect generated by some of the components optionally used to prepare the nanocomposites in the present invention, some mixtures have been processed without the addition of the compatibilizer agent (polypropylene grafted with maleic anhydride) or without using the solvent upon clay preparation, step (a).

Additionally, a test (Comparative example C1) was conducted following a methodology usually found in the state of the technique, in which the clay, previously swelled with the solvent, was mixed to the propylene treated with anti-oxidizing agent and polypropylene grafted with maleic anhydride, then, the mixture obtained was previously dried and ground before being supplied to the extruder.

For the compositions of the Comparative Examples, some additional essays have been performed using all essential components in the present invention, introducing, though, some modifications in the process, as described below:

The clay, swell in solvent, and mixed to the oil, has been added to the polypropylene, previously treated with the anti-oxidizing agent and the polypropylene grafted with maleic anhydride. The mixture obtained has been later dried with the use of a vacuum pump, to remove the solvent, ground, and only then, supplied to the extruder with the help of a solids dosimeter. After extrusion, the material was palletized.

In all Examples and Comparative Examples using the solvent to previously swell the clay, the ratio used was 11 g solvent per clay gram.

Mechanical properties of nanocomposites prepared in the Examples and Comparative Examples have been evaluated based on injected test specimens, and following the standards/methodologies below:
1) Flexural Modulus of nanocomposite was evaluated according to ASTM D-790.
2) Fluidity rate: The nanocomposite fluidity rate (FR) was established following method ASTM D-1238L.
3) Impact strength: The Izod impact strength was measured following method ASTM D-256 at 23° C.
4) Traction: Flow and at-break elongation, and flow stress were measured following method ASTM D-638.
5) Heat deflection temperature under load (HDT) of nanocomposite was measured according to ASTM D-648.

Thermal properties of nanocomposites obtained were established by scanning differential calorimetry, performed in a Thermal Analysis Instruments (DSC) system, with the following conditions: Heating from room temperature to 200° C. at 20° C. min⁻¹; (2) Isothermal for 5 min at 200° C.; (3) Cooling to −50° C. at 10° C. min⁻¹; (4) Isothermal for 5 min at −50° C. and (5) Second heating to 200° C. at a heating rate of 10° C. min⁻¹. The melting temperatures were taken in the second heating curves, and the enthalpy of fusion (ΔHₘ) of nanocomposites were calculated from the area of endothermic peak.

The results from the above mentioned tests are shown in TABLES 1, 2 and 3. Table 1 represents the Examples prepared with the use of a polypropylene, Table 2 relates to Examples conducted with propylene heterophasic co-polymer, and Table 3 shows the results obtained for the Comparative Examples, traditional processing. In this case, traditional processing means that the entire component to obtain the polyolefin's nanocomposite were added in the solids dosimeter of the extruder (FIG. 2 c), including the solvent and mineral oil, news component claimed in the present invention, but without the previous treatment described to obtain an emulsion.

The components mentioned in said Tables correspond to the following products:

PP1: Propylene homopolymer in the form of porous granules and fluidity rate 3.5 g/10 min;

PP2: Propylene heterophasic copolymer with ethene-propene rubber, fluidity rate 6.0 g/10 min and ethene content 8.5%;

Polybond 3002: polypropylene grafted with maleic anhydride with fluidity rate of 5.0 g/10 min, and was supplier by Crompton;

Cloisite Clay 15A: Organophilic clay obtained from a natural montmorilonite modified with quaternary ammonium salt, and was supplier by Southern Clay Products. The clay present 0.5% moist in weight, and a particles size distribution of 10% smaller than 2μ, 40% between 2 and 6μ, 40% between 6 and 13μ, and 10% larger than 13%;

MEK: Methyl-ethyl-ketone, with boiling point 72.1° C. and density 0.95 g/cc;

PPG: Polypropylene glycol with molecular weight 1000 g/mol, viscosity (25° C.) 190cP, density 1.005 g/cc and initial solidification temperature −36° C.;

EMCA plus 350: White mineral oil composed of a mixture of saturated paraffinic and naphthenic hydrocarbons, obtained from high pressure catalytic hydrogenation of petroleum distilled products (supplier by Empresa Carioca de Produtos Químicos S. A); viscosity (25° C.): 145 cP, density (25° C.): 0.865 g/cc and initial solidification temperature −9.0° C.

EMCA plus 85: White mineral oil composed of a mixture of saturated paraffinic and naphthenic hydrocarbons, obtained from high pressure catalytic hydrogenation of petroleum distilled products (supplied by Empresa Carioca de Produtos Químicos S. A); viscosity (25° C.) 36 cP, density (25° C.): 0.843 g/cc and initial solidification temperature −6.0° C.

Nanoblend 1001: Polypropylene based nanopolymer concentrate that present Nanomer® level from 38 to 42% in weight (supplier by PolyOne™, USA).

TABLE 1

| Samples | | | | | | |
|---|---|---|---|---|---|---|
| White | 1 | 2 | 3 | 4 | 5 | 6 |

Composition

| | | | | | | | |
|---|---|---|---|---|---|---|---|
| PP1 (%) | 100 | 94 | 89 | 85 | 94 | 89 | 89 |
| Polybond 3002 (%) | — | — | 5 | 5 | — | 5 | 5 |
| Cloisite 15A (%) | — | 5 | 5 | 5 | 5 | 5 | 5 |
| Oil | — | PPG | PPG | PPG | EMCA 350 | EMCA 350 | EMCA 350 |
| | | (1%) | (1%) | (5%) | (1%) | (1%) | (1%) |
| Solvent | — | MEK | MEK | MEK | — | — | MEK |
| Nanoblend 1001 (%)^{a} | — | — | — | — | — | — | — |

Mechanical properties

| | | | | | | | |
|---|---|---|---|---|---|---|---|
| FR (g/10 min) | 3.5 | 4.3 | 3.6 | 5.7 | 3.5 | 3.2 | 3.5 |
| Flexural Modulus (MPa) | 1860 | 2580 | 2200 | 2025 | 2244 | 2244 | 2500 |
| Flow Stress (MPa) | 37 | 36 | 36 | 31 | 37 | 37 | 37 |
| Flow Elongation (%) | 12.0 | 8.2 | 9.7 | 12 | 7.8 | 8.6 | 9.5 |
| At Break Elongation (%) | 273 | 114 | 169 | 340 | 118 | 173 | 193 |
| Izod Impact (23° C., J/m) | 45 | 111 | 74 | 127 | 52 | 51 | 68 |

Thermal properties

| | | | | | | | |
|---|---|---|---|---|---|---|---|
| Tm (° C.) | 163 | 164 | 164 | 169 | 163 | 163 | 164 |
| Tc (° C.) | 119 | 113 | 114 | 128 | 121 | 120 | 114 |
| ΔH melting (J/g) | 99 | 106 | 102 | 101 | 100 | 99 | 104 |
| HDT (0.455 MPa) | 90 | 113 | 112 | 110 | 115 | 112 | 110 |

| | Samples | | | | |
|---|---|---|---|---|---|
| | 7 | 8 | 9 | 10 | 11 |
| Composition | | | | | |
| PP1 (%) | 85 | 98 | 96 | 94 | 88.7 |
| Polybond 3002 (%) | 5 | — | — | — | — |
| Cloisite 15A (%) | 5 | 1 | 3 | 5 | — |
| Oil | EMCA 350 | EMCA 350 | EMCA 350 | EMCA 350 | — |
| | (5%) | (1%) | (1%) | (1%) | |
| Solvent | MEK | MEK | MEK | MEK | — |
| Nanoblend 1001 (%)^{a} | — | — | — | — | 11.3 |
| Mechanical properties | | | | | |
| FR (g/10 min) | 3.7 | 3.6 | 3.5 | 3.8 | 3.2 |
| Flexural Modulus (MPa) | 1735 | 1993 | 2065 | 2340 | 1975 |
| Flow Stress (MPa) | 32 | 37 | 38 | 36 | 38 |
| Flow Elongation (%) | 16.5 | 9 | 8.3 | 9.2 | 10.2 |
| At Break Elongation (%) | 353 | 98 | 85 | 180 | 124.3 |
| Izod Impact (23° C., J/m) | 117 | 67 | 80 | 117 | 51 |
| Thermal properties | | | | | |
| Tm (° C.) | 167 | 163 | 164 | 164 | — |
| Tc (° C.) | 118 | 120 | 120 | 113 | — |
| ΔH melting (J/g) | 102 | 99 | 99 | 106 | — |
| HDT (0.455 MPa) | 103 | 114 | 113 | 113 | — |

^{a}11.3% of Nanoblend 1001 resent 5% of organoclay (commercial product)

TABLE 2

| Samples | | |
|---|---|---|
| White | 12 | 13 |

Compositions

| | | | |
|---|---|---|---|
| PP2 (%) | 100 | 94 | 94 |
| Polybond 3002 (%) | — | — | — |
| Cloisite 15A (%) | — | 5 | 5 |
| Oil | — | EMCA 350 (1%) | PPG (1%) |
| Solvent | — | MEK | MEK |

Mechanical properties

| | | | |
|---|---|---|---|
| FR (g/10 min) | 6.0 | 4.5 | 4.6 |
| Flexural Modulus (MPa) | 1396 | 1550 | 1430 |
| Flow Stress (MPa) | 25.0 | 24.5 | 24.0 |
| Flow Elongation (%) | 7.5 | 7.0 | 8.0 |
| At-Break Elongation (%) | 242 | 302 | 377 |
| Izod Impact (23° C., J/m) | 128 | 565 | 707 |

Thermal properties

| | | | |
|---|---|---|---|
| Tm (° C.) | 165 | 165 | 165 |
| Tc (° C.) | 117 | 118 | 118 |
| ΔH melting (J/g) | 83 | 90 | 91 |
| HDT (0.455 MPa) | 90 | 110 | 112 |

TABLE 3

| Samples | | | | |
|---|---|---|---|---|
| White | C 1 | C 2 | C 3 | C 4 |

Composition

| | | | | | |
|---|---|---|---|---|---|
| PP1 (%) | 100 | 90 | 85 | 85 | 85 |
| Polybond 3002 (%) | — | 5 | 5 | 5 | 5 |
| Cloisite 15 A (%) | — | 5 | 5 | 5 | 5 |
| Oil | — | — | PPG | EMCA 85 | EMCA 350 |
| | | | (5%) | (5%) | (5%) |
| Solvent | — | MEK | MEK | MEK | MEK |

Mechanical properties

| | | | | | |
|---|---|---|---|---|---|
| FR (g/10 min) | 3.5 | 3.6 | 3.3 | 4.2 | 3.8 |
| Flexural Modulus (MPa) | 1860 | 1997 | 1643 | 1396 | 1432 |
| Flow Stress (MPa) | 37 | 21 | 23 | 26 | 27 |
| Izod Impact (23° C., J/m) | 45 | 59 | 95 | 77 | 63 |

Thermal properties

| | | | | | |
|---|---|---|---|---|---|
| Tm (° C.) | 163 | 163 | 165 | 163 | 164 |
| Tc (° C.) | 120 | 117 | 114 | 116 | 116 |
| ΔH melting (J/g) | 99 | 101 | 94 | 95 | 100 |
| HDT (0.455 MPa) | 90 | 101 | 92 | 105 | 112 |

At first, based on Table 1 analysis, it is possible to observe that all examples of nanocomposites prepared according to the present invention showed clearly superior properties to the homopolymer processed, named white, and to traditional nanocomposites obtained with materials made by prior art process, sample 11 (Table 1), specially in relation to the balance between toughness and impact strength properties, and thermal properties, specifically HDT. Also, FIG. 3 presents TEM micrographs for sample 2, Table 1. In this figure, the observations through the transmission electron microscopy (TEM) support that the present invention lead to a delamination or exfoliation of the organoclay. This is due to that we can observe single layers or small stacks of organoclay platelets dispersed in the continuous polymer phase.

Then, by comparing examples 1 and 10, respectively, to examples 2 and 6, it is evidenced that the use of the compatibilizer agent (Polybond 3002) upon preparation of nanocomposites is actually optional, considering the excellent results obtained in relation to homopolymer.

For comparative purposes, examples 8, 9 and 10 were conducted with different clay contents, maintaining the other conditions. It is possible to observe improved toughness and impact strength properties, when the amount of clay added increases.

Additionally, when examples 12 and 13 are compared to the “Blank” test, named also white, Table 2, an increase in the mechanical properties is observed. Specifically, a substantial improvement in Izod impact strength property of the co-polymer.

Finally, it may be observed that the good samples properties do not depend on the type of oil used, as long as they meet the specifications of the present invention.

Concerning the results from Comparative Examples on Table 3, it may be observed, in all samples tested, inferior mechanical properties to the ones obtained with the essays in the Examples representing the invention herein described and claimed, Table 1. And also, visually, the nanocomposites produced according to the present invention showed better optical properties.

When comparative Example C1 is compared to Examples 6 of Table 1, it may be observed that the latter have higher values, both to the Flexural Module and to the Izod Impact.

Additionally, when comparative Examples C2, C3 and C4 are compared to Examples 3 and 7 on Table 1, it may be observed that the Flexural Module and Izod Impact values were higher for the essays conducted according to the process in the present invention.

In a further aspect of the invention, a nanocomposite was prepared by combining and mixing the oil, solvent, polyolefin, and organophilic clay together in an extruder. The extrusion process for preparing the nanocomposite is similar to that described above, except that an emulsion was not formed prior to combining and mixing the components. In this embodiment, the clay and polymer are combined to form a polymer matrix wherein the clay is interdispersed within the polymer matrix. The polymer matrix is heated within the extruder to a sufficient temperature to cause flow of the polymer. Generally, the polymer is heated to its melting point or greater.

The advantages of this aspect of the invention are summarized in Table 4. In the preparation of Example 14 and comparative Examples C5-C7 the polymer and organophilic clay, oil and solvent were supplied in the solids dosimeter of the extruder. Preferably, the oil, solvent, polymer, and clay components are mixed before addition to the extruder to provide a homogeneous mixture. In this processing was used a vacuum pump to remove substantially all of the solvent from the mixture in a degassing zone. The mixture was then advanced out of the extruder to form a homogeneous nanocomposite material. After the extrusion, the material was pelletized.

Example 14 illustrates the improvements in properties of the nanocomposites that can be obtained by mixing both an oil and a solvent with the polymer and the organophilic clay. Comparative Examples C5-C7 were prepared without addition of the oil to extruder. From Table 4 it can be clearly seen that the presence of mineral oil provides significantly improved mechanical properties, such as flexural modulus and Izod impact strength. In particular, Example 14 has a flexural modulus of 2500 MPa whereas the closest comparative example, C7 has a flexural modulus of about 1800 MPa.

TABLE 4

Samples

| | | | |
|---|---|---|---|
| 14 | C5 | C6 | C7 |

Composition

| | | | | |
|---|---|---|---|---|
| P1 (%) | 89 | 89 | 89 | 89 |
| P2 (%) | — | 1 | 1 | — |
| Wax (%) | — | — | — | 1 |
| EMCA 350 (%) | 1 | — | — | — |
| Polybond 3002 (%) | 5 | 5 | 5 | 5 |
| Cloisite 15A (%) | 5 | 5 | 5 | 5 |
| Solvent | MEK | — | MEK | MEK |

Mechanical properties

| | | | | |
|---|---|---|---|---|
| Flexural Modulus (MPa) | 2500 | 1617 | 1507 | 1807 |
| Izod Impact (23° C.) J/m | 68 | 39 | 33 | 38 |

Thermal properties

| | | | | |
|---|---|---|---|---|
| HDT (0.455 MPa) | 110 | 107 | 100 | 96 |

P1: Propylene homopolymer in the form of porous granules and fluidity rate 3.5 g/10 min.
P2: Propylene homopolymer in the form of porous granules and fluidity rate 900-1000 g/10 min.
Wax: solid product composed of a mixture of hydrocarbons.
EMCA 350: White mineral oil composed of a mixture of saturated paraffinic and naphthenic hydrocarbons, obtained from high pressure catalytic hydrogenation of petroleum distilled products (supplier by Empresa Carioca de Produtos Quimicos S.A); viscosity (25□C): 145 cP, density (25° C.): 0.865 g/cc and initial solidification temperature −9.0° C.

Although the invention has been described based on exampling embodiments, it is understood that modifications may be introduced by skilled worker in the art, remaining within the inventive concept limits.

1. Process to prepare nanocomposites, characterized in that it comprises the following steps:
(a) add a solvent and an oil to an organophilic clay, with shaking, so as to obtain an emulsion;
(b) separately, heat a polymer up to at least its melting point; and
(c) mix the clay-containing emulsion, obtained in (a), with the previously melted polymer, obtained in (b).

2. Process, as recited in claim 1, characterized in that the organophilic clay used in (a) is a phyllosilicate superficially modified with an organic tensoactive.

3. Process, as recited in claim 1, characterized in that the amount of organophilic clay used in (a) varies from 0.2 to 10% in weight, based on the total weight of the final nanocomposite obtained.

4. Process, as recited in claim 3, characterized in that the amount of clay in step (a) varies from 0.5 to 7% in weight, based on the total weight of the final nanocomposite obtained.

5. Process, as recited in claim 1, characterized in that the solvent is a volatile organic solvent.

6. Process, as recited in claim 5, characterized in that the solvent is polar.

7. Process, as recited in claim 6, characterized in that the solvent is one or more among ketones, aldehydes, alcohols, esters, ethers, amines, organo-halogenated compounds and substances containing two or more among these chemical functions.

8. Process, as recited in claim 7, characterized in that the solvent is one or more among 3 to 8 carbons ketones and esters.

9. Process, as recited in claim 8, characterized in that the solvent is one or more among propanone, methyl-ethyl-ketone, methyl-isobutyl-ketone, ethyl acetate and butyl acetate.

10. Process, as recited in claim 5, characterized in that the solvent is used in step (a) in the ratio of 2 to 30 g solvent per clay gram.

11. Process, as recited in claim 5, characterized in that one additional step (f), related to solvent removal, is performed after step (d).

12. Process, as recited in claim 1, characterized in that the viscosity of the oil used in step (b) operation temperature is in the range from 20 to 600 cP.

13. Process, as recited in claim 12, characterized in that the viscosity of the oil used in step (a) operation temperature is in the range from 100 to 200 cP.

14. Process, as recited in claim 1, characterized in that the oil initial solidification temperature is lower than room temperature

15. Process, as recited in claim 1, characterized in that the oil is a mineral oil.

16. Process, as recited in claim 1, characterized in that the amount of oil used in step (b) varies from 0.2 to 12% in weight, compared to the total weight of the nanocomposite.

17. Process, as recited in claim 16, characterized in that the amount of oil used in step (a) varies from 0.5 and 6% in weight, compared to the total weight of the nanocomposite.

18. Process, as recited in claim 1, characterized in that the shaking used upon preparation of the emulsion with the clay is performed in vigorous conditions.

19. Process, as recited in claim 1, characterized in that the polymer used in step (c) is one among polyolefin, polar copolymer, elastomer, polyester, polystyrene and ABS.

20. Process, as recited in claim 19, characterized in that the polyolefin is one among polyethylene and its copolymers, or polypropylene and its copolymers.

21. Process, as recited in claim 1, characterized in that the polymer in step (c) is previously mixed to an anti-oxidizing and/or compatibilizer agent, step (e), with shaking.

22. Process, as recited in claim 21, characterized in that the compatibilizer agent is used in the ratio of 0 to 30% in weight, based on the total weight of the nanocomposite obtained.

23. Process, as recited in claim 22, characterized in that the compatibilizer agent is used in the ratio of 0 to 15% in weight, based on the total weight of the nanocomposite obtained.

24. Process, as recited in claim 1, characterized in that steps (c) and (d) are performed in an extruder

25. Process, as recited in claim 11, characterized in that steps (c), (d) and (f) are performed in an extruder

26. Process, as recited in claim 24, characterized in that the polymer is supplied to the initial part of the extruder, where melting occurs, while the emulsion is introduced in the homogenization zone.

27. Process, as recited in claim 25, characterized in that the polymer is supplied to the initial part of the extruder, where melting occurs, the emulsion is introduced in the homogenization zone, and the solvent is removed in the extruder degassing zone.

28. A process for preparing a nanocomposite comprising: combining a polymer, organophilic clay, solvent, and oil components; mixing the components to form a composite material wherein the organophilic clay is dispersed throughout the polymer; and removing substantially all of the solvent from the composite material.

29. The process of claim 28, further comprising the step of heating the polymer to at least its melting point.

30. The process of claim 28, further comprising the step of heating the polymer prior to the combining step.

31. The process of claim 28, characterized in that the components are combined and mixed in an extruder.

32. The process of claim 31 further comprising the step of advancing the nanocomposite mixture out of the extruder to form a nanocomposite material.

33. Nanocomposites, characterized in that they are prepared with the process as defined in claim 1.
